(19) United States
(12) Patent Application Publication
(10) Pub. No.: US 2017/0286613 A1
(43) Pub. Date: Oct. 5, 2017

(54) PREDICTIVE APPLICATION TO IDENTIFY AND REMEDY MEDICAL HEALTH CONCERNS

(71) Applicant: International Business Machines Corporation, Armonk, NY (US)

(72) Inventors: Michael Bender, Rye Brook, NY (US); Rhonda L. Childress, Austin, TX (US); Michael J. Spisak, East Northport, NY (US)

(21) Appl. No.: 15/088,890

(22) Filed: Apr. 1, 2016

(51) Int. Cl. G06F 19/00; G06Q 10/10

(52) U.S. Cl. CPC G06F 19/3406; G06F 19/3456; G06F 19/322; G06Q 10/1095

(57) ABSTRACT

User health concerns may be managed by a monitoring application which identifies user medications, medical conditions and known symptoms corresponding to those medical conditions. The known data may be identified along with environmental factors, which are compared to determine a likelihood of the user experiencing the symptoms. A tolerance threshold of the user is also relevant to the type of planning and dosage necessary to alleviate the condition. A certain medication dosage suggestion notification can then be created for the user to take the medication based on the likelihood of the user experiencing the symptom and the user's tolerance threshold.

### TECHNICAL FIELD

This application relates to identifying health related risks and determining ways to mitigate the risks and more particularly to identifying a user's schedule and current health condition status and providing notifications to the user to provide optimal health advice.

### BACKGROUND

User health conditions which are known can be mitigated through treatment options, such as medication, advice, etc. However, a person may become ill or experience elevated health problems due to unexpected circumstances and an inability to plan ahead and prepare for schedule anomalies and potential future health issues.

### SUMMARY

One example method may include at least one of identifying, by a server, at least one medication associated with a user profile of a user, identifying, by the server, at least one medical condition associated with the user profile and at least one symptom corresponding to the medical condition, determining, by the server, environmental factors, comparing, by the server, the environmental factors to the at least one medical condition and determining a likelihood of the user experiencing the at least one symptom, identifying, by the server, a tolerance threshold of the user to take the at least one medication, and creating, by the server, a medication dosage suggestion notification for the user to take the at least one medication based on the likelihood of the user experiencing the at least one symptom and the tolerance threshold.

Another example embodiment may include an apparatus that includes a processor configured to perform at least one of identify at least one medication associated with a user profile of a user, identify at least one medical condition associated with the user profile and at least one symptom that corresponds to the medical condition, determine environmental factors, compare the environmental factors to the at least one medical condition and determine a likelihood of the user to experience the at least one symptom, identify a tolerance threshold of the user to take the at least one medication, and create a medication dosage suggestion notification for the user to take the at least one medication based on the likelihood of the user to experience the at least one symptom and the tolerance threshold, and a transmitter configured to transmit the medication dosage suggestion notification.

Yet another example embodiment may include a non-transitory computer readable medium configured to store instructions which when executed causes a processor to perform at least one of identifying at least one medication associated with a user profile of a user, identifying at least one medical condition associated with the user profile and at least one symptom corresponding to the medical condition, determining environmental factors, comparing the environmental factors to the at least one medical condition and determining a likelihood of the user experiencing the at least one symptom, identifying a tolerance threshold of the user to take the at least one medication, and creating a medication dosage suggestion notification for the user to take the at least one medication based on the likelihood of the user experiencing the at least one symptom and the tolerance threshold.

### BRIEF DESCRIPTION OF THE DRAWINGS

FIG. 1 illustrates a network diagram of a user operating a user device in a present location and anticipating a future location according to an example embodiment.

FIG. 2 illustrates a logic diagram of information resource gathering performed by a predictive application management application and server according to an example embodiment.

FIG. 3 illustrates a logic flow diagram of the operation of the predictive application according to an example embodiment.

FIG. 4 illustrates a system signaling diagram of the communication among entities operating during a predictive analysis according to example embodiments.

FIG. 5 illustrates a system device diagram configured to perform one or more example operations of the various example embodiments.

FIG. 6 illustrates an example network entity device configured to store instructions to perform one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments.

The instant features, structures, or characteristics of described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments, the application may be applied to many types of network data, such as, packet, frame, datagram, etc. The term “message” also includes packet, frame, datagram, and any equivalents thereof. Furthermore, while certain types of messages and signaling are depicted in exemplary embodiments they are not limited to a certain type of message, and the application is not limited to a certain type of signaling.

Example embodiments provide a system, method and device to utilize a user's location via a user device to provide medical health assistance. In one example, a predicted environmental condition for a specific location (i.e., current location, future location, likely location, etc.) can be identified and cross-referenced with user health history information. For example, known user conditions, medications prescribed and/or being taken by the user, can be identified along with user status information, such as a user location, prescription status information (i.e., days since last prescription, nearest pharmacy, etc.), current location, future location, upcoming travel plans.

During the user health screening procedure, the application may process the known information and determine that a user should initiate a dosing session based on a schedule of future events. The dosing session may be deemed a pre-dosage session in lieu of travel plans which could limit regular dosage circumstances (i.e., train, plane, etc.). Also, known attributes related to the environment at a past, present and/or future location may also affect the dosage decision to take a medication and at a particular time based on a user's calendar application indicating the future travels plans. A user may also have chronic conditions, a known health status, weight, age, and other variables which could be considered tolerance thresholds which could reduce or increase the amount of medication taken at a particular time.

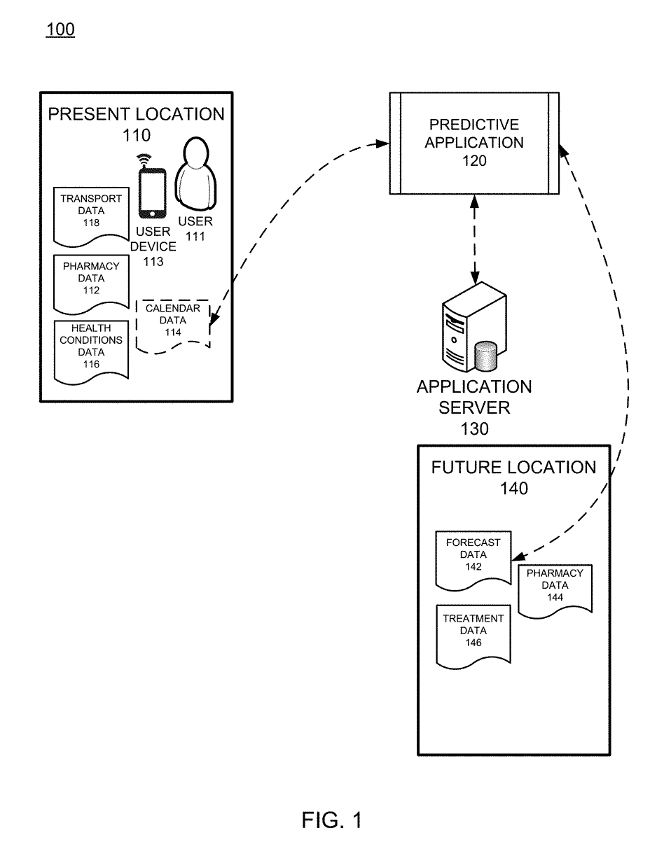

FIG. 1 illustrates a network diagram of a user operating a user device in a present location and anticipating a future location according to an example embodiment. Referring to FIG. 1, the network 100 includes a present location 110 of a user 11 and user device 113 operated by the user. The information or data segments associated with the present location may be identified by the predication application 120 as including various segments of data, such as transport data 118 of a type of transport used by a user no and/or in the future, pharmacy data 112 of a pharmacy a user frequents at the present location, health conditions which are known 116 and which may include known prescriptions, procedures undergone by the user, etc.

Also, a more likely data source used by the predictive application to initiate a suggestion creation procedure may be the calendar data 114. For instance, as a calendar application provides data 114 indicating a user is going to board a flight to another state in the U.S. in a few days, the user's medical history information may then be identified as posing a risk to the user's health in the event that the user has a health concern related to the upcoming travel event. The concern may be the need to plan ahead and secure more of a particular medication prior to boarding a flight or train or boat, etc. The concern may also be the need to pre-dose a medication that would assist with treating a condition and avoiding a particular known symptom likely to occur at the new location. For instance, allergy count at the destination may be high and pre-dosing a particular amount of medication may avoid headaches and irritation to the user at a later time. The user's tolerance thresholds can be cross-referenced to confirm that the user uses the optimal amount of medication and at the correct time.

The application server 130 may be responsible for hosting the application 120. The future location 140 may be referenced once the travel plans are identified. The future location may be referenced for forecast data 142, pharmacy data 144, treatment data 146, etc. A third party information source may be a web-based server and website that offers suggestions and remedies to certain known conditions and ailments. The forecast data for weather, allergies, epidemics can also be identified from a third party information source in order to create a suggestion and notify the user device via a suggestion notification message.

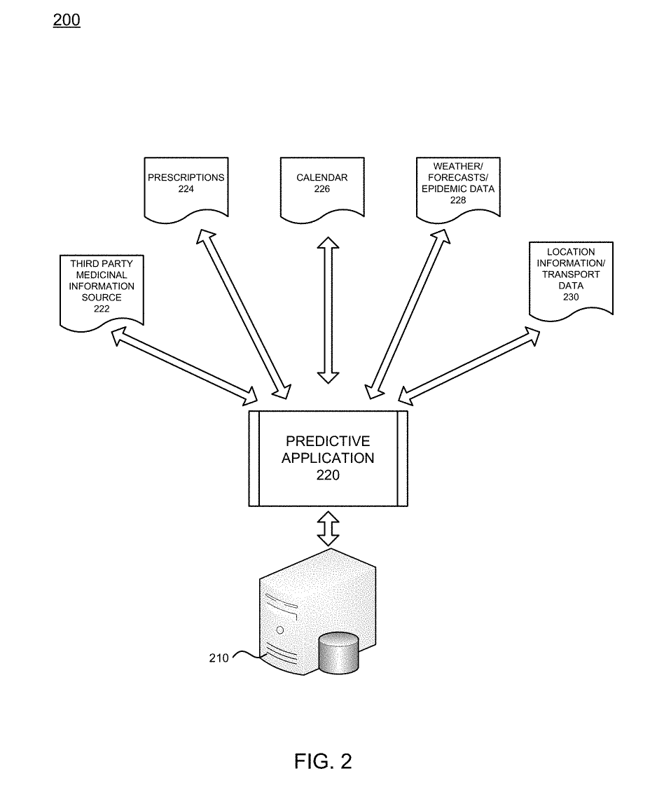

FIG. 2 illustrates a logic diagram of information resource gathering performed by a predictive application management application and server according to an example embodiment. Referring to FIG. 2, the logic diagram 200 includes the predictive application 220 operates on a server 210 and references multiple data instances to identify a user's present health status and future health status and whether to suggest health related remedies. A user may have known/historical data related to his or her health included in a health profile. Such information may include current prescriptions 224, current calendar information 226, etc. Also, other information pertaining to the future of the user's health may be referenced, such as third party medicinal information 222, weather and forecasts and epidemic data (i.e., flu counts in various locations) 228 and location information and transport data 230 for future travel plans.

Various data elements or instances throughout this disclosure are disclosed as factors in the notification/suggestion procedure performed by the predictive application 220. The result of the application processing may be any of a suggestion to take a medication, order a medication, avoid certain foods, sleep more, sleep less, ingest water and other fluids, etc.

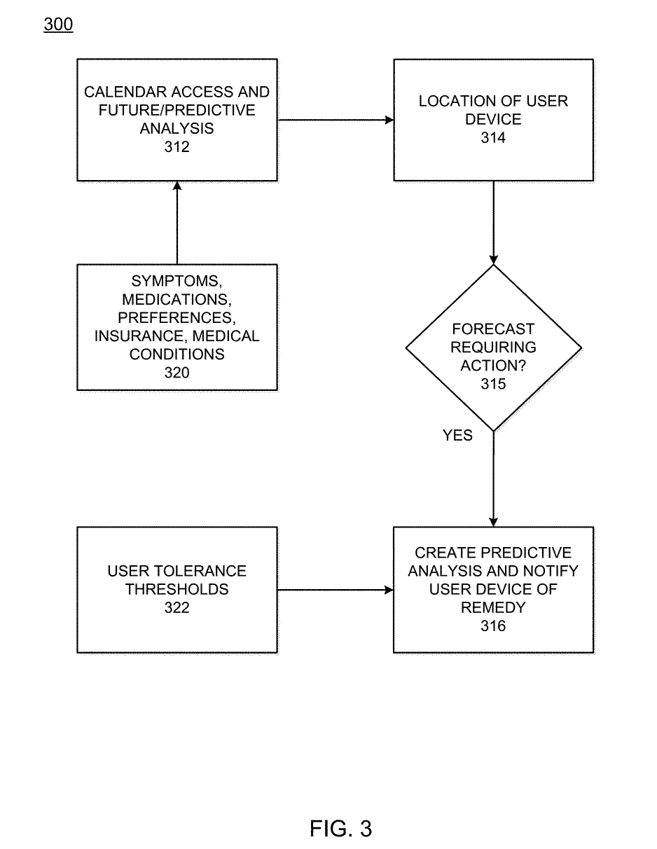

FIG. 3 illustrates a logic flow diagram of the operation of the predictive application according to an example embodiment. Referring to FIG. 3, the procedure performed by the predictive application may include a series of operations 300 including a calendar access operation and/or other future predictive actions performed 312 to determine a user's health in the current state and in the future. The user location may be one option to also identify via location technologies pertaining to the user's mobile device, such as GPS, triangulation, IP address and/or power estimation. The calendar application may identify a future location that is imminent and thus the forecast for weather, allergies, epidemics may then be identified and depending on the results, action 315 may be necessary to maintain proper health concerns for the user, such medication, pre-dosing, regular dosing, etc. The action trigger may cause a predictive analysis to begin which weighs the user's location, future location, past medical conditions, common symptoms, previous health concerns, forecast results, tolerance threshold of the user, etc., to determine whether a particular remedy is necessary 316. The user tolerance thresholds 322 and the various known user health history 320 may be provided as a basis for determining which medicines the user may take and how much the user is capable of handling without causing health concerns.

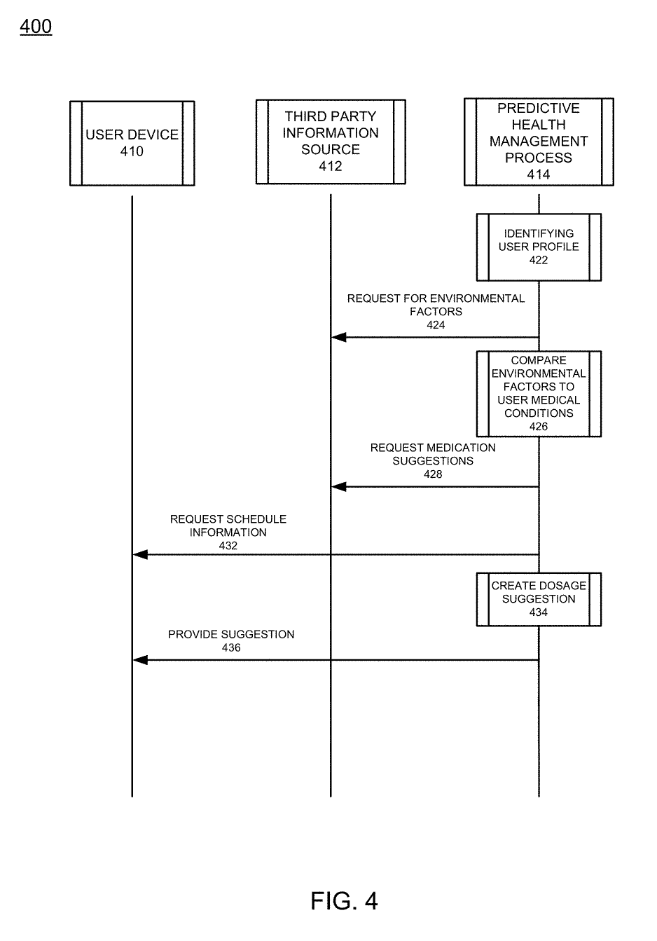

FIG. 4 illustrates a system signaling diagram of the communication among entities operating during a predictive analysis according to example embodiments. Referring to FIG. 4, the system diagram 400 includes three entities including the user device 410 which may include user location information, user actions, user profiles, such as a user health profile, etc. The next entity may be a third party database, website, information source, etc., 412. The information source can be referenced at any time for updated health care information, such as common treatments plans, medicines, and other treatment options for certain known conditions, symptoms and potential illnesses. The last entity is the predictive health management process 414 which could be a server or other device used to process the predictive application. In operation, the server 414 may perform identifying a medication associated with a user profile 422 of a user and/or other conditions, such as previous health conditions, past procedures the user has undergone, chronic illnesses, and even tolerance thresholds. For purposes of this example, the server may identify one or more medical conditions associated with the user profile and at least one symptom corresponding to the medical condition. The process 414 may then determine environmental factors 424 from a third party information source 412 and compare the environmental factors to the medical condition(s) and determine a likelihood of the user experiencing the at least one symptom based on the data collected. The likelihood determination may be based on a comparing operation and may be a function of the user health conditions, the environmental factors, and previous health conditions 426. A score may be calculated and a threshold value may be used as a basis to determine whether medical suggestions should be made and forwarded to the user device. During the determination procedure, the third party information source 412 may be referenced for known treatment options 428, such as medications. Also, the user device may be referenced for schedule and calendar information 432 which confirm the user may be traveling to a location with elevated health risks.

Continuing with the same example, the server may identify the user tolerance threshold to take the at least one medication identified from the third party information source. As a result, the server can then create a medication dosage suggestion notification 434 for the user to take the at least one medication based on the likelihood of the user experiencing the at least one symptom and the tolerance threshold. The suggestion may be forwarded to the user as a notification or suggestion 436. Examples of the environmental factors may be based on at least one of a present location, a previous location, a recently traveled location, a frequently visited location, an upcoming calendar event, a future location, a climate forecast, an epidemic status, and an allergy forecast. Also the user tolerance threshold is based on at least one of an age of the user, a health condition of the user, a medical history of the user, a previously administered medical procedure to the user, an allergy of the user, and a weight of the user.

When the server transmits the request to the third party health information source for medical treatment options related to the environmental factors the result may be receiving a suggestion to take a medication associated with at least one of the environmental factors and the medical condition. To further exemplify the procedure, the server 414 may calculate a medication time for the user to take the medication based on the environmental factors and/or the medical condition(s) identified, and send a medication dosage notification to the user device 420 associated with the user when the medication time has matured.

In another example, the server may identify an event date in a calendar application associated with the user, a future location of the user based on the event date, a travel time to the future location, the environmental factors at the future location, a pre-dosage amount of the medication based on the environmental factors and the travel time and then provide to the user device associated with the user, the pre-dosage amount of the medication and a time to consume the medication.

A user may be identified via his or her user device location from a GPS coordinate location technique or power estimation from cellular communication towers (i.e. triangulation). In operation, the user may be monitored to identify any potential health concern that are likely to effect the user's health. In one example, the user device may be in communication with a server operating the health management process 414 which monitors the user device health conditions and prescriptions to automatically request a prescription in a present location and/or a future location depending on the travel plans and other criteria. Certain local and/or remote factors may affect the user's imminent health status such as inclement weather, travel time, transport type. For instance, if a hurricane is in the path of travel, the user may experience a layover and would not be able to fill a prescription in the target location due to the delay and the medication may be critical to the user's health (i.e., insulin, blood pressure, etc.). A medication severity procedure could identify the medication as imminent and not permit the user to wait until the arrival city to fill the prescription and other measures may be taken to reduce the health condition threat. Also, the suggestion to pre-dose the user by a define quantity and suggest the user not eat salty foods or sugary foods may provide a remedy in the event that the user is likely to miss a day of medication. According to another example, future location information may be used to identify medical facilities within a predefined area of the user's anticipated location may be identified and provided to the user in the event of an anticipated emergency, such as shortness of breath or other acute symptoms. The notification may invoke an insurance audit that retrieves the user's health insurance information and provides it to the user in an email with the medical facility locations and any relevant information in the event of an emergency.

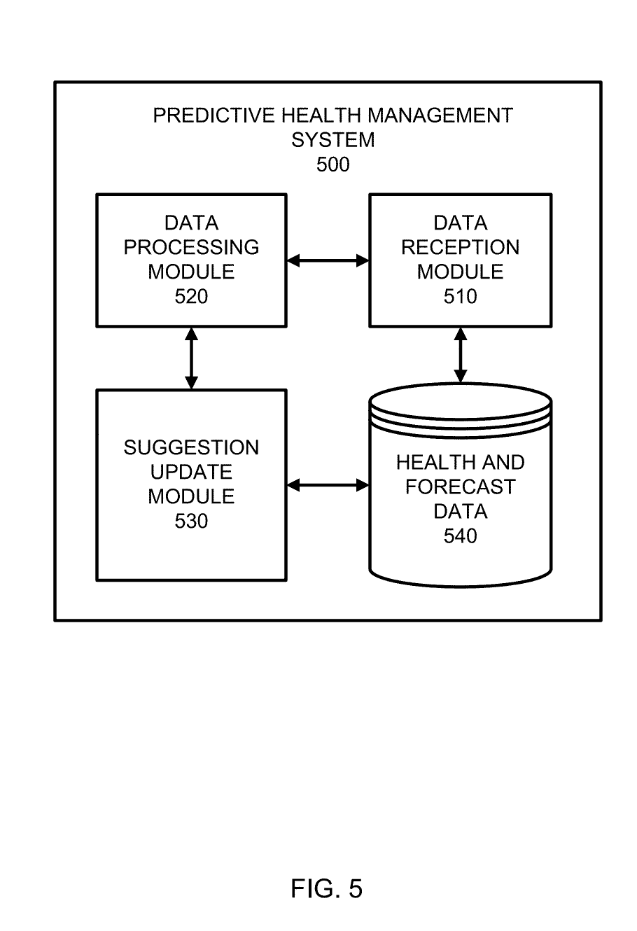

FIG. 5 illustrates a predictive health management system 500 which may be a server, servers, mobile device, or any operating device with a processor and memory. In one example, the system 500 may be a server having various processing modules including a reception module 510 for data received, a processing module 520 for data processing, an update module 530 for suggestion creation and notifications and a storage unit 540 for storing the information and related records necessary to perform the processing and the updating procedures.

The example system 500 may perform one or more processes related to the various embodiments. In one example, the user's medications/supplements/regiments may be tracked along with various symptoms that a person is experiencing. The current plans, climate forecasts, epidemic forecasts and allergy forecasts may all be identified and a tolerance threshold for each individual can be identified prior to determining a remedy for that particular user. The data input module 510 may receive known medical information for conditions and treatments and the various data elements may be used to create recommendations, such as a time to start the medication based on individual tolerance thresholds and individual historical medication usage. This may provide a basis for the number of milligrams of a particular medication given the known user tolerance and the severity of the user schedule.

The user's travel plans may include various different locations, transport vehicles, etc. Also, the individual's historical movement and location information activity via GPS and other location information which is received as an input to the input module 520. The relevant data can then be used to process via the processing module 520, the amount of pre-dosing of the medication necessary to accommodate the user's near term plans. All the known user data, and the related environmental conditions may all be stored in the database 540. The amount of time required for the medication to become effective may also be identified via the pre-dosage calculations including resulting time for dispensing/consuming the medication. Also, micro-level data may be used to identify a user's specific medication regiment, such as a particular allergen level (i.e., ragweed, tree pollen, grass pollen, mold, etc.) and apply that data to the amount of a particular medication the user may administer. Another remedy example may include identifying a particular condition and medication, such as blood thinners when flying, sea-sickness medication when cruising, antibiotics before going to a dentist, neurological calming medicine before a presentation, anti-inflammatory before increased physical activity and any other medication treatment options which can be predicted based on a user's calendar of appointments and commitments.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

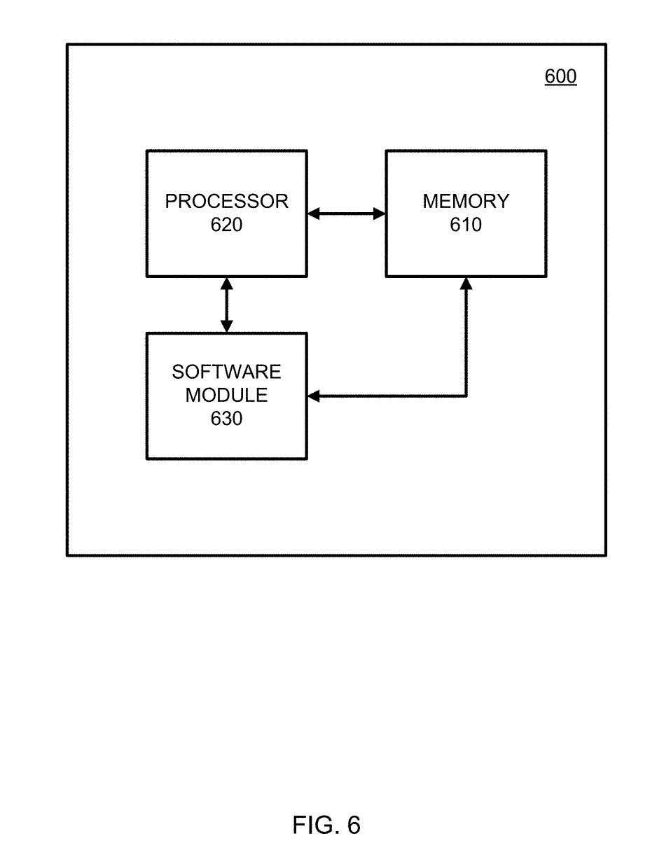

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example network element 600, which may represent any of the above-described network components, etc.

As illustrated in FIG. 6, a memory 610 and a processor 620 may be discrete components of a network entity 600 that are used to execute an application or set of operations as described herein. The application may be coded in software in a computer language understood by the processor 620, and stored in a computer readable medium, such as, a memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
identifying, by a server, at least one medication associated with a user profile of a user;
identifying, by the server, at least one medical condition associated with the user profile and at least one symptom corresponding to the medical condition;
determining, by the server, environmental factors;
comparing, by the server, the environmental factors to the at least one medical condition and determining a likelihood of the user experiencing the at least one symptom;
identifying, by the server, a tolerance threshold of the user to take the at least one medication; and
creating, by the server, a medication dosage suggestion notification for the user to take the at least one medication based on the likelihood of the user experiencing the at least one symptom and the tolerance threshold.

2. The method of claim 1, wherein the environmental factors are based on at least one of a present location, a previous location, a recently traveled location, a frequently visited location, an upcoming calendar event, a future location, a climate forecast, an epidemic status, and an allergy forecast.

3. The method of claim 1, wherein the tolerance threshold is based on at least one of an age of the user, a health condition of the user, a medical history of the user, a previously administered medical procedure to the user, an allergy of the user, and a weight of the user.

4. The method of claim 1, further comprising:
transmitting, by the server, a request to a third party health information source for medical treatment options related to the environmental factors; and
receiving, by the server from the third party health information source, a suggestion to take a medication associated with at least one of the environmental factors and the at least one medical condition.

5. The method of claim 1, further comprising:
initiating, by the server, a medication time for the user to take the at least one medication based on at least one of the environmental factors and the at least one medical condition; and
transmitting, by the server, a medication dosage notification to a user device associated with the user when the medication time has matured.

6. The method of claim 1, further comprising:
identifying, by the server, an event date in a calendar application associated with the user;
identifying, by the server, a future location of the user based on the event date; and
determining, by the server, a travel time to the future location.

7. The method of claim 6, further comprising:
determining the environmental factors at the future location;
determining, by the server, a pre-dosage amount of the at least one medication based on the environmental factors and the travel time; and
providing, by the server to a user device associated with the user, the pre-dosage amount of the at least one medication and a time to consume the medication.

8. An apparatus comprising:
a processor configured to:
identify at least one medication associated with a user profile of a user;
identify at least one medical condition associated with the user profile and at least one symptom that corresponds to the medical condition;
determine environmental factors;
compare the environmental factors to the at least one medical condition and determine a likelihood of the user to experience the at least one symptom;
identify a tolerance threshold of the user to take the at least one medication; and
create a medication dosage suggestion notification for the user to take the at least one medication based on the likelihood of the user to experience the at least one symptom and the tolerance threshold; and
a transmitter configured to transmit the medication dosage suggestion notification.

9. The apparatus of claim 8, wherein the environmental factors are based on at least one of a present location, a previous location, a recently traveled location, a frequently visited location, an upcoming calendar event, a future location, a climate forecast, an epidemic status, and an allergy forecast.

10. The apparatus of claim 8, wherein the tolerance threshold is based on at least one of an age of the user, a health condition of the user, a medical history of the user, a previously administered medical procedure to the user, an allergy of the user, and a weight of the user.

11. The apparatus of claim 8, wherein the transmitter transmits a request to a third party health information source for medical treatment options related to the environmental factors, and receives from the third party health information source, a suggestion to take a medication associated with at least one of the environmental factors and the at least one medical condition.

12. The apparatus of claim 8, wherein the processor is further configured to initiate a medication time for the user to take the at least one medication based on at least one of the environmental factors and the at least one medical condition, and the transmitter is configured to transmit a medication dosage notification to a user device associated with the user when the medication time has matured.

13. The apparatus of claim 8, wherein the processor is further configured to identify an event date in a calendar application associated with the user, identify a future location of the user based on the event date, and determine a travel time to the future location.

14. The apparatus of claim 13, wherein the processor is further configured to determine the environmental factors at the future location, determine a pre-dosage amount of the at least one medication based on the environmental factors and the travel time, and the transmitter is further configured to provide to a user device associated with the user, the pre-dosage amount of the at least one medication and a time to consume the medication.

15. A non-transitory computer readable storage medium configured to store instructions that when executed cause a processor to perform:
identifying at least one medication associated with a user profile of a user;
identifying at least one medical condition associated with the user profile and at least one symptom corresponding to the medical condition;
determining environmental factors;
comparing the environmental factors to the at least one medical condition and determining a likelihood of the user experiencing the at least one symptom;
identifying a tolerance threshold of the user to take the at least one medication; and
creating a medication dosage suggestion notification for the user to take the at least one medication based on the likelihood of the user experiencing the at least one symptom and the tolerance threshold.

16. The non-transitory computer readable storage medium of claim 15, wherein the environmental factors are based on at least one of a present location, a previous location, a recently traveled location, a frequently visited location, an upcoming calendar event, a future location, a climate forecast, an epidemic status, and an allergy forecast.

17. The non-transitory computer readable storage medium of claim 15, wherein the tolerance threshold is based on at least one of an age of the user, a health condition of the user, a medical history of the user, a previously administered medical procedure to the user, an allergy of the user, and a weight of the user.

18. The non-transitory computer readable storage medium of claim 15, wherein the processor is further configured to perform:
transmitting, by the server, a request to a third party health information source for medical treatment options related to the environmental factors; and
receiving, by the server from the third party health information source, a suggestion to take a medication associated with at least one of the environmental factors and the at least one medical condition.

19. The non-transitory computer readable storage medium of claim 15, wherein the processor is further configured to perform:
initiating, by the server, a medication time for the user to take the at least one medication based on at least one of the environmental factors and the at least one medical condition; and
transmitting, by the server, a medication dosage notification to a user device associated with the user when the medication time has matured.

20. The non-transitory computer readable storage medium of claim 15, wherein the processor is further configured to perform:
identifying, by the server, an event date in a calendar application associated with the user;
identifying, by the server, a future location of the user based on the event date; and
determining, by the server, a travel time to the future location;
determining the environmental factors at the future location;
determining, by the server, a pre-dosage amount of the at least one medication based on the environmental factors and the travel time; and
providing, by the server to a user device associated with the user, the pre-dosage amount of the at least one medication and a time to consume the medication.
